(19) United States
(12) Patent Application Publication
(10) Pub. No.: US 2001/0030154 A1
(43) Pub. Date: Oct. 18, 2001

(54) Shower water treatment filters

(76) Inventors: Robert Lehrer, Wilmington, DE (US); Richard D. Harwick, Wilmington, DE (US)

Correspondence Address: Connolly Bove Lodge & Hutz LLP, P. O. Box 2207, Wilmington, DE, 19899-2207, US

(21) Appl. No.: 09/727,167

(22) Filed: Nov. 30, 2000

Related U.S. Application Data
(60) Provisional application No. 60/168,460, filed on Dec. 2, 1999.

(51) Int. Cl. B01D 35/02; B01D 27/06

(52) U.S. Cl. 210/446

(57) ABSTRACT

Shower water treatment filters comprise a functional filter using the principles and technique of tortuous path technology wherein the filter is contained within a housing so that the housed filter can be easily and conveniently enclosed within and also removed from the overall device.

### CROSS-REFERENCE TO RELATED APPLICATION

This application is based upon provisional application Ser. No. 60/168,460, filed Dec. 2, 1999.

### BACKGROUND OF THE INVENTION

The variable quality of, and perhaps the undesirable content in, water entering homes around the globe today is accentuated by the growing number of so-called “water purification” devices or systems available to a consumer from a growing number of sources. Some of the systems sold are so-called “central” or “whole house” systems, which filter, and/or clean, and/or soften water used for every household purpose; such systems are costly, may not be effective in some situations, and require frequent filter/cartridge changes and maintenance either by the homeowner or via periodic calls from a service provider.

Another manifestation of home type water filtration devices is the “Under the Sink” style, less costly than the “whole house” types (due to their more limited capacities for contaminant removal) but with the same requirement for periodic filter/cartridge changes by or for the user. These devices function mainly to provide treated water for consumption in beverages and/or for various cooking or food preparation applications.

A third series of water filter devices enjoying growing popularity includes the various cartridge types: kitchen or bathroom faucet attachments, water line filters for refrigerator ice-makers, etc.

In general, except for the costly central home water treatment units, water used for showering or bathing remains untreated in the home. Yet the same possibilities exist that such water may contain undesirable chemicals or dissolved metals as exists for water the homeowner is otherwise filtering. And that water, if it is contaminated, will certainly contact the skin and eyes, and perhaps cause unwanted consequences either at the time, or over time. It is possible that the skin and eyes of infants may be particularly vulnerable to such contaminants.

### SUMMARY OF THE INVENTION

The present invention is based upon the use of filter structure which will be later described for water used for showering and bathing.

In accordance with this invention a filter cartridge includes a housing which is connected to a source of liquid, such as water, at one end of the housing. A filter unit is disposed within the housing. The filter is of multi-layer form wherein portions of each layer are impervious to the flow of liquid and other portions are pervious to the flow of liquid so that liquid flowing through the filter is caused to flow in a tortuous path. The housing includes a flow outlet for the filtered liquid. A shower head or other liquid applicating member is mounted to the outlet end of the housing for discharging the filtered liquid. Preferably, the housing contains an openable door to permit removal and replacement of the filter unit.

The Invention may broadly be considered as a liquid treatment device which may be used not only in the sense of removing impurities and the like from the liquid, but may also be used to provide additives or enhancing substances to the liquid in addition to or instead of the filter function.

### THE DRAWINGS

FIG. 1 is a perspective view of a liquid treatment cartridge in accordance with this invention;

FIG. 2 is a cross-sectional view in elevation of the cartridge shown in FIG. 1;

FIG. 3 is a cross-sectional view in elevation showing the cartridge of FIGS. 1-2 with the door illustrated in phantom;

FIG. 4 is a top plan view of a spirally wound liquid treatment element usable in the cartridge of FIGS. 1-3;

FIG. 5 is a side elevational view showing a further form of liquid treatment element in the form of individual stacked sheets usable in the cartridge of FIGS. 1-3;

FIG. 6 is a top plan view of the element shown in FIG. 5;

FIG. 7 is a perspective view showing yet another form of element in the form of an accordion folder single sheet usable in a cartridge of this invention;

FIG. 8 is a cross-sectional plan view showing the element of FIG. 7 mounted in a square cross section cartridge;

FIG. 9 is a side elevational view showing the cartridge of FIGS. 1-3 permanently mounted to a shower head; and

FIG. 10 is a view similar to FIG. 9 showing a cartridge detachably mounted to a shower head.

### DETAILED DESCRIPTION

The present invention is based upon the following considerations:

1. Contaminants could include organic chemicals, pesticide chemicals. Chlorine or chlorine-containing compounds, metals such as aluminum or lead or iron, etc.; and

2. Devices containing one or a combination of absorbents such as activated charcoals, ion exchange materials, minerals and/or underivatized or derivatized silicas, aluminas, etc-acting as “solid phase extraction” (SPE) media-are effective water treating/purification agents; and

3. Filtration devices using such materials can be and are applied to substrates via later described patented and patent pending technology to yield highly efficient treating and filtering of various fluids, including water, for diverse applications; and

4. Issues such as temperature effects on function, dwell times, flow rates, adsorbent capacities, possible contamination levels of the water, PLUS convenience in use of a filter device, user's maintenance costs, product appearance, product pricing, etc. must be addressed early in concept and product design.

The structure for the device may be based upon the various filter type structure disclosed in copending application Ser. No. 09/273,110 filed Mar. 19, 1999, as well as U.S. Pat. Nos. 5,304,305, 5,567,461, 5,885,633 and 5,958,478. All of the details of that application and the patents are incorporated herein by reference thereto.

In general, the device used in accordance with this invention may have the following characteristics:

1. A device which can be quickly connected to and disconnected from the shower water pipe (to which a shower head is usually attached) comprising a functional filter constructed using the principles and techniques of “tortuous path” technology, such filter contained within a housing such that the housed filter can be easily and conveniently enclosed within, and also removed from, the overall device. The “tortuous path” technology is achieved by providing each layer of filter material with portions which are pervious to the flow of liquid, while other portions are impervious to the flow of liquid. Thus, the liquid can not flow straight through the filter. Instead the liquid must take a tortuous path which causes a more efficient filtering action.

2. The device in 1. Above, “quick connected” on the one end to the shower water pipe and on the other end to a shower head via a standard or “quick connect” coupling.

3. The device in 1. Above, contained within, or constructed as a part of the body of, a shower head of any type (plain, pulsating, misting, etc.), such shower head being connected in any manner to the shower water pipe.

4. The housed filter in 1. above, constructed using the principles and techniques of “tortuous path” technology, containing a coated sheet or sandwich of several or many sheets (a laminated structure) in any one of the many sizes, volumes, geometrical shapes (including spiral wound), etc., which are adequate to produce the desired filtration function in the application.

5. The device in 1. above, constructed using the principles and techniques of “tortuous path” technology, designed and using materials such that it functions as designed in the application, without leaking, under conditions of:

hot, warm or cold water,

“normal” or near normal shower water flow rates

convenience of filter removal and disposal after use

6. The housed filter in 1. above, designed to be discarded after a single use

7. The housed filter in 1. above, designed to be discarded after multiple uses, and including in the device design and function, an indicator communicating to the user that the housed filter has completed its usefulness and should be replaced.

8. A device such as in 1. above, comprising a functional filter constructed using the principles and techniques of “tortuous path” technology, and/or using one or more known state of the art Solid Phase Extraction materials—such as high surface area particulate absorbents—such filter contained within a housing such that the housed filter can be easily and conveniently enclosed within, and also removed from, the overall device.

9. The device in 8. above, “quick connected” on the one end to the shower water pipe and on the other end to a shower head via a standard or “quick connect” coupling.

10. The device in 8. above, contained within, or constructed as a part of the body of, a shower head of any type (plain, pulsating, misting, etc.), such shower head being connected in any manner to the shower water pipe.

11. The housed filter in 8. above, constructed using the principles and techniques of “tortuous path” technology, containing a coated sheet or sandwich of several or many sheets (a laminated structure) in any one of the many sizes, volumes, geometrical shapes (including spiral wound), etc., which are adequate to produce the desired filtration function in the application.

12. The device in 8. above, constructed using the principles and techniques of my “tortuous path” technology, designed and using materials such that it functions as designed in the application, without leaking, under conditions of:

hot, warm or cold water,

“normal” or near normal shower water flow rates

convenience of filter removal and disposal after use

13. The housed filter in 8. above, designed to be discarded after a single use

14. The housed filter in 8. above, designed to be discarded after multiple uses, and including in the device design and function, an indicator communicating to the user that the housed filter has completed its usefulness and should be replaced.

15. A tub may be filled with bath water, in instances where a bathtub and shower combination exists, via the shower devices described here by simply running the shower instead of the tub faucet; where the tub and shower are separate, a pail or other suitable device could be used to fill the tub from filtered shower water collected in the pail.

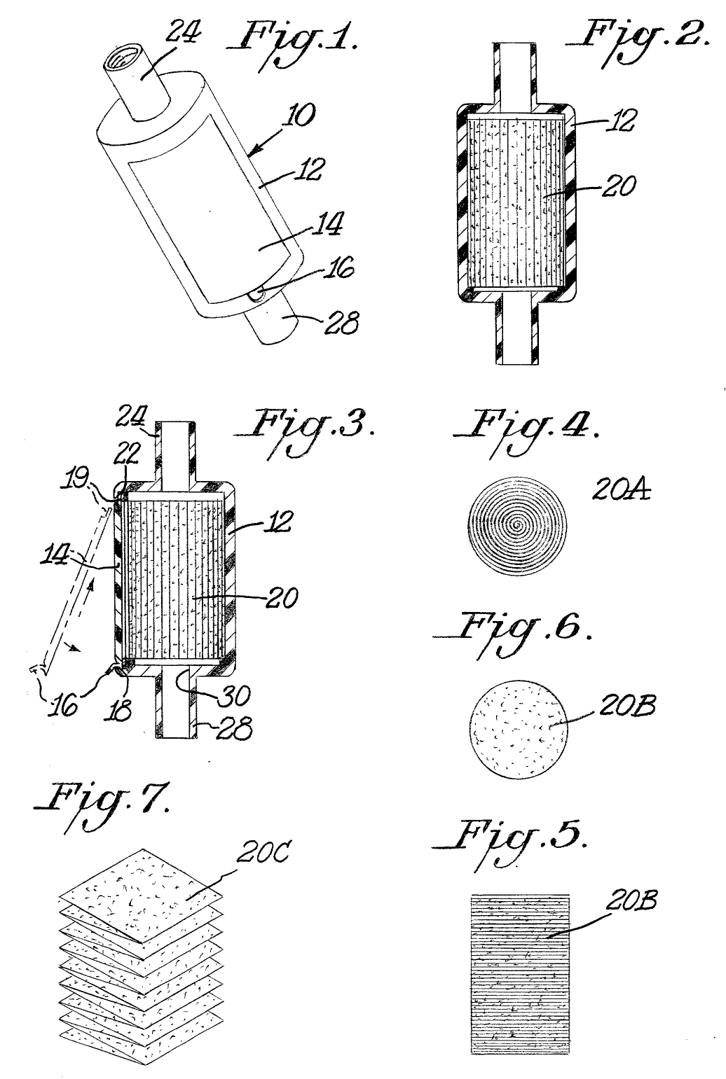

FIGS. 1-3 show a filter cartridge 10 in accordance with this invention. As shown therein the cartridge includes a housing 12 which has an openable door 14. Door 14 may be opened in any suitable manner. As shown in FIGS. 1 and 3 a finger grip 16 is provided on door 14. Finger grip 16 may be a spring finger which would snap into a groove 18 (FIG. 3) while the upper portion of door 14 includes a shoulder 19 that would fit into a groove 22 in housing 12. To remove door 14, finger grip 16 would be pulled outwardly and the door could then be lowered away from the housing opposite to the direction of the arrows shown in FIG. 3. When it is desired to replace door 14 the door would be slid upwardly as shown by the upward arrow in FIG. 3 and the door would be moved inwardly as also shown by the sideward arrow in FIG. 3 to snap finger grip 16 into place.

It is to be understood that the above manner of construction of door 14 is for exemplary purposes. Other forms of construction may be used such as by hinging or pivoting the upper end of door to the housing, such as shown by door 14A in FIGS. 8 and 10.

Mounted within the housing 12 is a liquid treatment unit 20. In the preferred practice of the invention the liquid treatment is filtering, although as later described the unit 20 may be used for adding enhancing substances to the liquid. Filter unit 20 is constructed of multiple layers of filter material. Each layer includes portions which are pervious to the flow of liquid and other portions which are impervious to the flow of liquid as described in the above noted patents and application. As a result, liquid flowing through the filter unit must take a tortuous path, rather than flowing straight through the filtering unit. This enhances the filtering action.

As also shown in FIGS. 1-3 an inlet sleeve 22 is provided at the upper or upstream end of housing 12 for mounting to a source of liquid such as a water supply pipe 24, as shown in FIGS. 9 and 10. Any suitable means of attachment may be used such as having the inner surface of sleeve 22 threaded complementary to the thread on the outer surface of pipe 26. The lower or downstream end of housing 12 would include a discharge attachment sleeve 28. Discharge sleeve 28 includes a discharge opening 30.

FIG. 10 illustrates an embodiment of the invention wherein sleeve 28 would be detachably mounted to a shower head 32 by means of a threaded coupling between sleeve 28 and the shower head attachment 34. This permits either the shower head or the filter cartridge to be readily replaced without requiring the other member to be replaced.

FIG. 9 shows an alternative where the shower head 36 is integral with cartridge 10 and communicates with cartridge 10 through the discharge opening 30.

The filter unit may take various forms. FIG. 4, for example, shows a filter unit 20A which is in coil form by being spirally wound upon itself and in that manner forms the multiple layers of filter material.

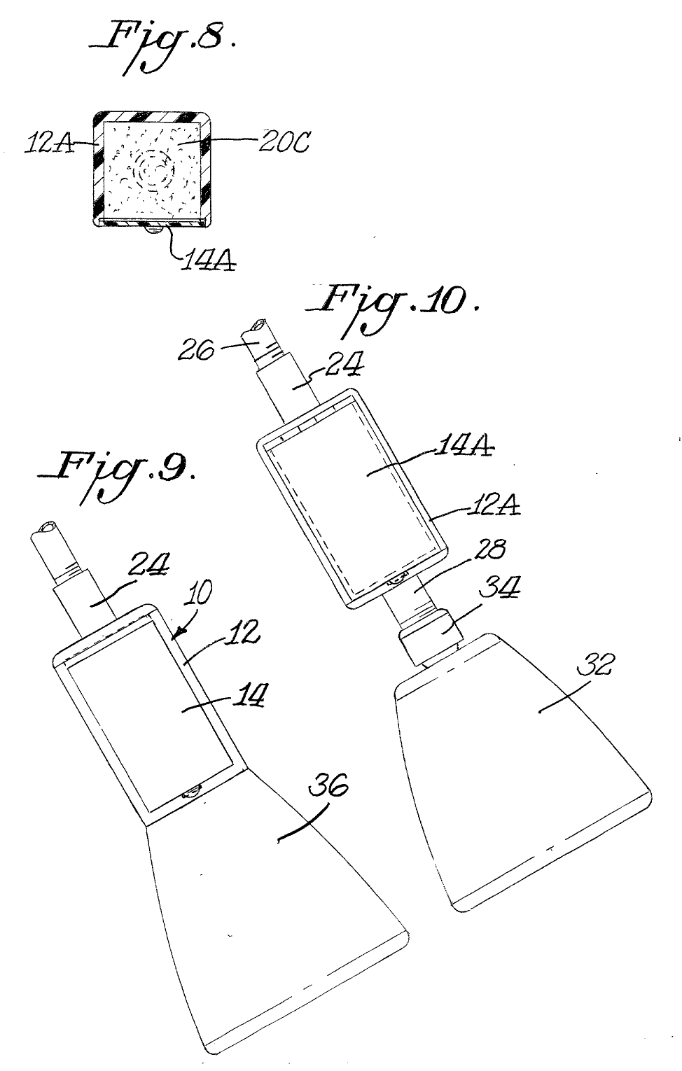

FIGS. 5-6 show an alternative where the filter unit 20B is in the form of individual filter pads or sheets stacked atop each other.

FIG. 7 shows yet another form where the filter unit 20C is a single sheet folded upon itself in accordion type fashion to form the individual layers.

Where the filter unit is of non-circular cross section such as the square layers of filter unit 20C, the housing 12A may likewise be of the same shape as shown in FIGS. 8 and 10.

It is to be understood that the invention may have various applications such as for use as a faucet filter, sprinkler or with a shower head. It is also to be understood that the invention may be practiced not only for removal purposes, but also to add substances. For example, when used for treating shower water, the “filter” may add skin conditioner or aloe. The adding action could be accomplished while the same “filter” is removing contaminants or only as a mechanism for adding substances without any removal action. The added substances could be incorporated in printed form or as particulates or liquid. The device of the invention could be used in combination with solid matter such as already used, e.g. quartz. It is also to be understood that the additive and/or adsorbent material need not be incorporated in the device by printing and need not be in a form to use tortuous technology.

As is apparent, the invention may thereby be considered as being directed to the treatment of a liquid in providing a liquid treating unit which may act as a filter for removing substances and/or may enhance the liquid by adding substances.

What is claimed is:

1. A liquid treating cartridge comprising a housing, a liquid treating unit within said housing, said liquid treating unit being of multi-layer form, each layer of said unit having portions thereof which are pervious to the flow of liquid and other portions which are impervious to the flow of liquid so that the liquid is caused to flow in a tortuous path through the unit, said housing including a liquid flow inlet at one end thereof adjacent to one end of said treating unit, said housing further including a flow outlet at an end thereof opposite said one end and opposite said end of said unit whereby liquid entering said housing is discharged from said housing after flowing through said unit, attaching structure at said one end of said housing for attachment to liquid supply pipe, and said flow outlet of said housing being disposed for flow communication with a liquid discharge member.

2. The cartridge of claim 1 wherein said housing includes a door for permitting the ready replacement of said unit with a further unit.

3. The cartridge of claim 2 wherein said liquid treatment unit is a filter.

4. The cartridge of claim 2 wherein said unit is a single sheet bent to form said layers.

5. The cartridge of claim 4 wherein said single sheet is in coil form.

6. The cartridge of claim 4 wherein said single sheet is of accordion form.

7. The cartridge of claim 2 wherein said fluid discharge member is a shower head.

8. The cartridge of claim 7 wherein said shower head is detachably mounted to said housing.

9. The cartridge of claim 7 wherein said shower head is integrally mounted to said housing.

10. The cartridge of claim 2 wherein said unit is a filter having adsorbent material incorporated therein.

11. The cartridge of claim 10 wherein said filter further includes additive material for being added to the liquid flowing therethrough.

12. The cartridge of claim 2 wherein said layers incorporate additive material for adding substances to the liquid flowing there through.

13. A liquid treating cartridge comprising a housing, a liquid treating unit in said housing, said liquid treating unit being of multilayer form, each of said layers incorporating treating substances applied thereto by printing, a flow inlet at one end of said housing, a flow outlet at an opposite end of said housing, said unit being disposed between said flow unit and said flow outlet, attaching structure for securing said housing to a liquid supply pipe for permitting liquid to flow into said housing, and said flow outlet including an outlet opening for the discharge of treated liquid from said housing.
